(19) United States
(12) Patent Application Publication
(10) Pub. No.: US 2007/0051777 A1
(43) Pub. Date: Mar. 8, 2007

(54) SOLDERING METHOD

(75) Inventors: Takahito Yamaguchi, Saitama (JP); Norio Hasegawa, Saitama (JP); Toru Kato, Ibaraki (JP); Hideki Mukuno, Ibaraki (JP); Masahiko Asano, Ibaraki (JP)

Correspondence Address: DARBY & DARBY P.C., P. O. BOX 5257, NEW YORK, NY, 10150-5257, US

(73) Assignees: TAMURA CORPORATION, Nerima-ku (JP); TAMURA FA SYSTEM CORPORATION, Sayama-shi (JP); HITACHI, LTD., Chiyoda-ku (JP)

(21) Appl. No.: 11/470,088

(22) Filed: Sep. 5, 2006

(30) Foreign Application Priority Data
Sep. 8, 2005 (JP) 2005-260076

(51) Int. Cl. A47J 36/02

(52) U.S. Cl. 228/101

(57) ABSTRACT

This invention provides a soldering method capable of solving soldering defects due to excess molten solder in the case of soldering while applying an inner pressure into a through-hole of a lead component mounting substrate: (a) In a primary soldering step, a lead component mounting substrate is lowered, and the rear surface thereof is put close to or brought into close contact with an upper end opening edge of a nozzle. Simultaneously, the soldering surface of the molten solder supplied to the nozzle is elevated. (b) In a secondary soldering step, the rear surface of the lead component mounting substrate is relatively spaced from the soldering surface of molten solder by lowering the soldering surface. (c) In a lead separating step, the lead component mounting substrate is elevated while tilting the lead component mounting substrate.

### INCORPORATION BY REFERENCE

The present application claims priority under 35 U.S.C. §119 to Japanese Patent Application No. 2005-260076 filed on Sep. 8, 2005. The content of the application is incorporated herein by reference in its entirety.

### FIELD OF THE INVENTION

The present invention relates to a soldering method for soldering a lead component mounting substrate using molten solder supplied from a nozzle.

### BACKGROUND OF THE INVENTION

The following local soldering apparatus has been known. In the local soldering apparatus, a tank body storing molten solder is provided at a position where a substrate transporting means for transporting a lead component mounting substrate having a surface on which a lead component is mounted stops the transfer of the lead component mounting substrate. The molten solder contained in the tank body is supplied to a local nozzle attached to the tank body by a pump provided in the tank body. The lead of the lead component projected to the rear surface side of the substrate from a through-hole of the lead component mounting substrate is soldered to a land of the substrate surface by the soldering surface of the molten solder jetted from an upper surface opening of the nozzle (e.g. see Japanese Laid-Open Patent Publication No. 11-28564 (pages 3 to 4, FIG. 2)).

In the local soldering apparatus, the lead component mounting substrate is lowered as shown by a dashed and two-dotted chain line As in FIG. 9 while the soldering surface of the molten solder jetted from the nozzle is elevated as shown by a solid line As in FIG. 9. The lead projected to the rear surface of the substrate is soldered to the substrate surface land while a soldering surface level and a substrate surface level are maintained constant as shown by the solid line Bs and the dashed and two-dotted chain line Bp. After soldering the lead, the lead component mounting substrate is elevated as shown by a dashed and two-dotted chain line Cp in FIG. 9 while the soldering surface of the nozzle is lowered as shown by a solid line Cs in FIG. 9.

When the local soldering is appropriately carried out, as shown in FIG. 6, the molten solder is wetted up to the surface land 6 of the lead component mounting substrate 2 through the lead 5 inserted into the through-hole 4 formed in the lead component mounting substrate 2 from a printed-circuit board on which the lead component 1 is mounted, that is, a rear surface land 3 of the lead component mounting substrate 2. A solder fillet 7 of a suitable amount is formed between the lead 5 and the rear surface land 3, and a solder fillet 8 of a suitable amount is formed between the lead 5 and the surface land 6.

However, since a spray fluxer applies flux from the rear surface side of the lead component mounting substrate 2 in a flux application before local soldering, the flux is applied to the rear surface land 3, through-hole 4 and lead 5 inserted into the through-hole 4 of the lead component mounting substrate 2. However, the flux is hardly applied to the surface land 6 of the substrate 2.

Thereby, since the molten solder is not fully supplied to the surface land 6 of the lead component mounting substrate 2 as shown in FIG. 7, and the molten solder does not spread on the surface land 6, a soldering defect in which the solder fillet 8 of the surface side shown in FIG. 6 is hardly formed, that is, a through-hole non-elevating phenomenon occurs. The tendency is particularly remarkable when the lead component 1 has high heat drawing performance or when a solder material is a high melting point material such as lead-free solder.

On the other hand, when an internal pressure is applied into the through-hole 4 of the lead component mounting substrate 2 by bringing the nozzle into close contact with the rear surface of the lead component mounting substrate 2, and fully elevating the molten soldering surface, as shown in FIG. 8, the molten solder is wetted up on the lead 5, and thereby the solder fillet 8 can be formed also on the surface land 6 of the lead component mounting substrate 2.

Thus, for example, even in products having high heat drawing performance, the molten solder can be elevated to the surface land 6 of the lead component mounting substrate 2 by applying an internal pressure into the through-hole 4 of the lead component mounting substrate 2. Also, even in the solder material having a high melting point, such as the lead-free solder, the molten solder can be elevated to the surface land 6 of the lead component mounting substrate 2 in a comparatively low temperature region, and the solder fillet 8 can be formed also on the surface land 6 of the lead component mounting substrate 2.

However, when the molten soldering surface is elevated and an internal pressure is applied into the through-hole 4 of the lead component mounting substrate 2, a problem due to the excess molten solder at the side of the rear surface land 3 occurs.

For example, at the time of a release operation for separating the lead 5 as a substrate mounting component from the molten soldering surface, the breaking of solder at the side of the rear surface land 3 is worsened. A so-called bridge in which the solder fillets are formed between a plurality of leads is easily generated. When solder immersion time is long while the soldering surface elevated as shown by the solid line Bs in FIG. 9 depending on the application condition of flux is high, a problem exists in that a so-called swelling solder fillet 7a is easily formed on the rear surface land 3 of the lead component mounting substrate 2 as shown in FIG. 8.

### SUMMARY OF THE INVENTION

The present invention has been accomplished in view of the foregoing and other problems in the related art. It is an object of the present invention to provide a soldering method capable of solving the soldering defect due to the excess molten solder in the case of soldering while applying an internal pressure into the through-hole of the lead component mounting substrate.

The present invention provides a soldering method including: a primary soldering step of applying supply pressure of molten solder supplied from a nozzle into a lead-insertion through-hole from a rear surface side of a lead component mounting substrate having a surface on which a lead component is mounted; a secondary soldering step of relatively spacing the rear surface of the lead component mounting substrate from a soldering surface of the nozzle and immersing only a lead projected from the through-hole of the lead component mounting substrate in the soldering surface of the nozzle for more than a certain period of time; and a lead separating step of relatively separating the lead of the lead component mounting substrate from the soldering surface of the nozzle. In the primary soldering step, the molten solder is wetted up to the surface side of the substrate on the lead by applying an internal pressure into the through-hole of the lead component mounting substrate using the supply pressure of the molten solder from the nozzle, and there by the solder fillet of the surface side of the substrate can be reliably formed. In the secondary soldering step, only the lead of the lead component mounting substrate is immersed in the soldering surface of the nozzle for more than a certain period of time in a state where the rear surface of the lead component mounting substrate is relatively spaced from the soldering surface of the nozzle. Thereby, the solder fillet of the rear surface side of the substrate can be formed by the molten solder of a suitable amount, and the soldering defects such as the solder bridge between the plurality of leads and the swelling solder fillet of the rear surface side of the substrate can be suppressed.

The present invention also provides a soldering method, wherein the secondary soldering step includes: a fillet forming step for relatively and gradually spacing the rear surface of the lead component mounting substrate from the soldering surface of the nozzle to form a solder fillet between the rear surface of the lead component mounting substrate and the lead; and a finishing step for fixing a spacing position of the soldering surface of the nozzle and rear surface of the lead component mounting substrate to immerse only the lead in the molten solder. In the fillet forming step, the solder fillet having a suitable shape can be formed by relatively and gradually spacing the rear surface of the lead component mounting substrate from the soldering surface of the nozzle. In the finishing step, the molten solder of a proper amount is permeated to only the lead by fixing the spacing position of the soldering surface of the nozzle and rear surface of the lead component mounting substrate, and a soldering defect such as an icicle in which the solder hangs down from the tip of the lead can be effectively suppressed.

According to another feature of the present invention, there is provided a soldering method, wherein the lead separating step relatively separates the lead from the soldering surface of the nozzle while tilting the lead of the lead component mounting substrate. Since the lead is relatively separated from the soldering surface of the nozzle while the lead is tilted in the lead separating step, the tip face of the lead can be smoothly separated from the soldering surface, and the soldering defects such as a solder bridge between the leads, a swelling solder fillet and an icicle at the tip of the lead can be suppressed.

According to yet another feature of the present invention, there is provided a soldering method, further including an overflow step for making the molten solder overflow from the nozzle immediately before the primary soldering step. Since the primary soldering step is carried out after the molten solder is overflowed from the nozzle by the overflow process and oxides are removed from the soldering surface of the nozzle, a soldering defect due to the oxides can be suppressed.

### BRIEF DESCRIPTION OF THE DRAWINGS

FIG. 1 is a process chart showing an embodiment of a soldering method according to the present invention, FIG. 1 (a) being a front view of a nozzle and substrate showing a primary soldering step, FIG. 1 (b) being a front view of a nozzle and substrate showing a secondary soldering step, and FIG. 1 (c) being a front view of a nozzle and substrate showing a lead separating step.

FIG. 2 is a partially cutout front view showing an example of a soldering apparatus for executing the soldering method.

FIG. 3 is a graph representing another embodiment of the soldering method according to the present invention by a change with the passage of time of the height positions of a substrate surface and nozzle soldering surface.

FIG. 4 is a flowchart showing the control of the height positions of the substrate surface and nozzle soldering surface in the soldering method.

FIG. 5 is a graph representing still another embodiment of the soldering method according to the present invention by a change of a solder wave height.

FIG. 6 is a substrate sectional view showing a normal solder fillet formation state of a lead component mounting substrate.

FIG. 7 is a substrate sectional view showing a soldering defect due to a through-hole non-elevating phenomenon of the lead component mounting substrate.

FIG. 8 is a substrate sectional view showing a soldering defect of the lead component mounting substrate in which a swelling solder fillet is formed.

FIG. 9 is a graph representing a conventional soldering method by a change with the passage of time of the height positions of the substrate surface and nozzle soldering surface.

### DETAILED DESCRIPTION OF THE PREFERRED EMBODIMENT

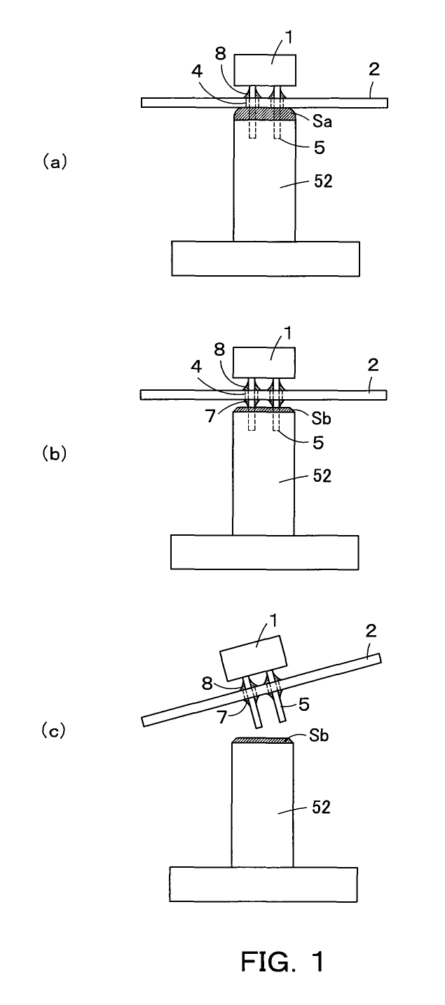

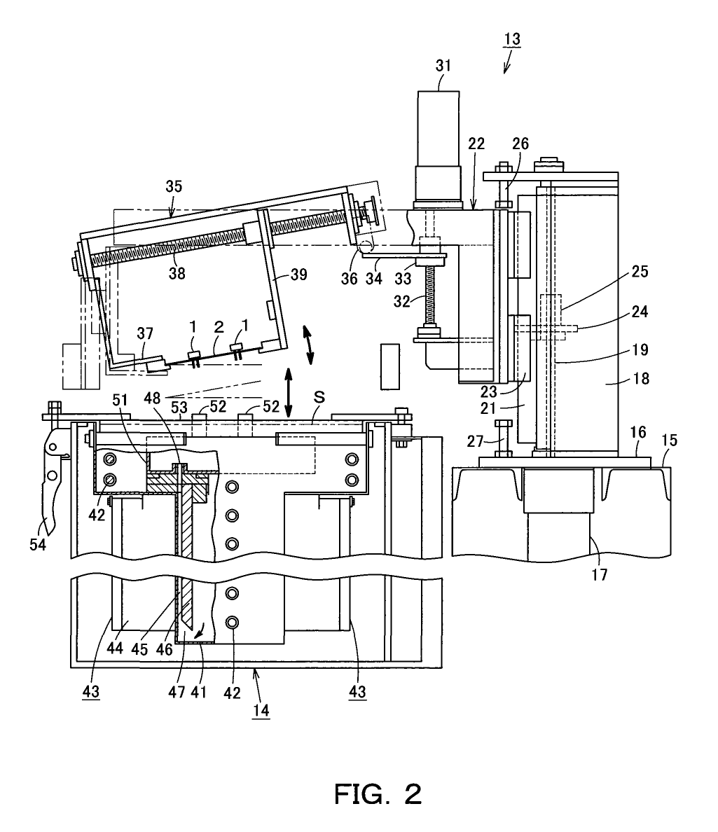

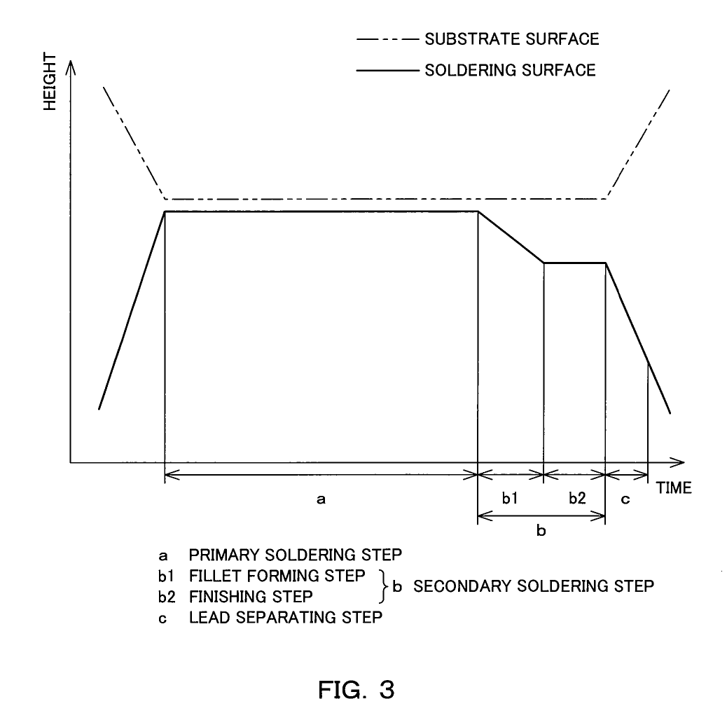

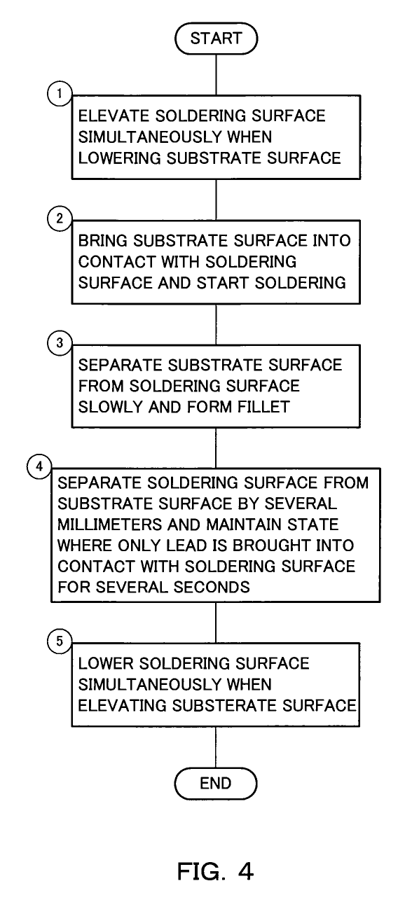

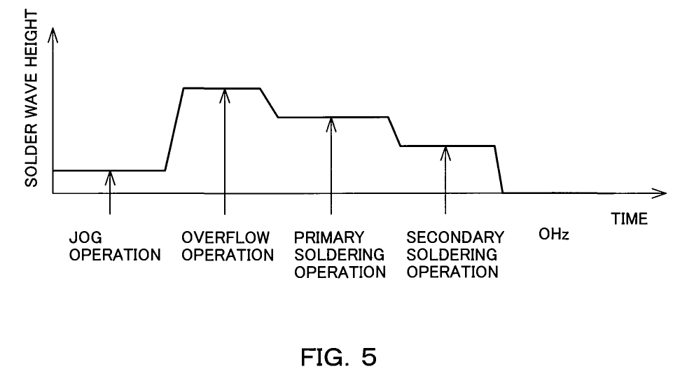

Hereinafter, the present invention will be described in detail with reference to an embodiment shown in FIGS. 1 and 2, another embodiment shown in FIGS. 3 and 4 and still another embodiment shown in FIG. 5. A local soldering apparatus shown in FIG. 2 is used also for the embodiment shown in FIG. 3 or 5.

As shown in FIG. 2, the local soldering apparatus is provided with a substrate elevating/lowering mechanism 13 for holding, tilting, and elevating/lowering a lead component mounting substrate 2 having a surface on which a lead component 1 is mounted, and a solder tank 14 capable of locally supplying molten solder.

In the substrate elevating/lowering mechanism 13, a motor unit 17 such as a motor and a decelerator is attached to a body frame 15 via an attachment plate 16. An elevating/lowering frame support 18 is installed upright on the attachment plate 16, and a feed screw 19 such as a ball screw rotated by the motor unit 17 is rotatably provided on the attachment plate 16. A guide rail 21 is provided on the elevating/lowering frame support medium 18 parallel with the feed screw 19.

A slide part 23 of the elevating/lowering frame 22 is elevatably and lowerably fitted onto the guide rail 21. A female screw part 25 attached to the elevating/lowering frame 22 via an attachment plate 24 is screwed into the feed screw 19. The elevating/lowering frame 22 is constituted so as to be elevated or lowered by rotating the feed screw 19 in the forward or reverse direction using the motor unit 17. Upper and lower stoppers 26 and 27 are arranged so as to face the upper surface and lower surface of the elevating/lowering frame 22.

A motor unit 31 such as a motor and a decelerator is attached on the base body end part of the elevating/lowering frame 22, and a feed screw 32 such as a ball screw rotated in the forward or reverse direction by the motor unit 31 is rotatably provided. A locking board 34 capable of being elevated/lowered by screwing a female screw part 33 onto the feed screw 32 is provided. A locked part 36 provided at one side part of a tilting frame 35 is locked by the locking board 34. The other side part of the tilting frame 35 is rotatably supported by the tip part of the elevating/lowering frame 22 via a hinge or the like.

A fixing support plate 37 is attached to one side part of the tilting frame 35, and a movable support plate 39 provided so as to be moved back/forth by a feed screw 38 according to a substrate width is attached to the fixing support plate 37. The lead component mounting substrate 2 is held by the fixing support plate 37 and the movable support plate 39.

In the solder tank 14 for local soldering, a solder melting heater 42 is set in a solder tank body 41 storing molten solder S supplied to the lead component mounting substrate 2. Electromagnetic induction pumps 43 are respectively set at one side and the other side of the solder tank body 41.

Referring to each of the electromagnetic induction pumps 43, an induction coil 44 wound around a primary iron core is set in the vertical direction outside the solder tank body 41. On the other hand, a secondary iron core 46 is set in the vertical direction inside the solder tank body 41 via a solder elevating passage 45. An inlet 47 and an outlet 48 are respectively opened at the lower end part and upper end part of the solder elevating passage 45.

A box-type nozzle base body 51 is fitted with the outlet 48 of each of the electromagnetic induction pumps 43, and a plurality of nozzles 52 corresponding to the arrangement or the like of the lead component 1 are projected upward on the nozzle base body 51. The plurality of nozzles 52 are provided so as to correspond to the plurality of electromagnetic induction pumps 43, and soldering surfaces having wave heights individually set can be respectively obtained by the pumps 43.

Since the nozzle base body 51 and the nozzles 52 are removably provided in the outlet 48, and are fixed by a clamp mechanism 54 via a retaining plate 53, the nozzle base body 51 and the nozzles 52 can be exchanged according to the lead component 1 of the lead component mounting substrate 2.

In the electromagnetic induction pump 43, a shifting magnetic field is generated in the solder elevating passage 45 by supplying a current which is shifted in phase such as three-phase current to the induction coil 44, and upward thrust due to electromagnetic induction is applied to conductive molten solder in the solder elevating passage 45. The molten solder is discharged from the outlet 48, and the molten solder is supplied to the upper end opening of the nozzle 52. The soldering surface of the molten solder is elevated or overflow-jetted on the nozzle 52. The height of the soldering surface or jetting soldering surface of the nozzle 52 is adjusted by controlling the power supply frequency supplied to the induction coil 44 of the electromagnetic induction pump 43.

Next, a local soldering method using the local soldering apparatus shown in FIG. 2 will be described with reference to FIG. 1.

The primary soldering step shown in FIG. 1 (a), the secondary soldering step shown in FIG. 1 (b), and the lead separating step shown in FIG. 1 (c) are continuously carried out by the relative operation of the same nozzle 52 and same lead component mounting substrate 2.

In the primary soldering step shown in FIG. 1 (a), the locking board 34 is lowered by rotating the feed screw 32 using the motor unit 31, and thereby the lead component mounting substrate 2 having the surface on which the lead component 1 is mounted is made horizontal. Furthermore, the elevating/lowering frame 22 is lowered by rotating the feed screw 19 using the motor unit 17, and the lead component mounting substrate 2 is horizontally lowered. Thereby, the rear surface of the lead component mounting substrate 2 is put close to or brought into close contact with the upper end opening edge of the nozzle 52.

Simultaneously, the supply pressure of the molten solder supplied from the nozzle 52 is applied into the lead insertion through-hole 4 from the rear surface side of the lead component mounting substrate 2 by controlling the power supply frequency of the electromagnetic induction pump 43 to elevate the soldering surface of the molten solder Sa supplied to the upper end opening of the nozzle 52. This state is maintained for several seconds.

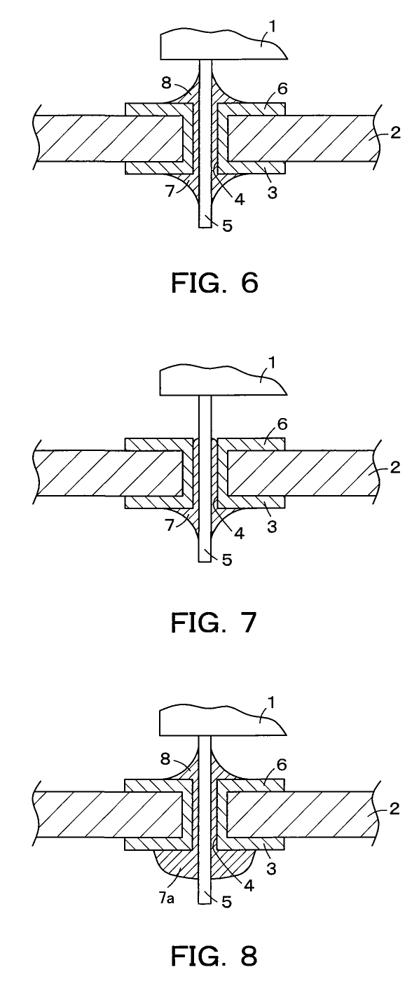

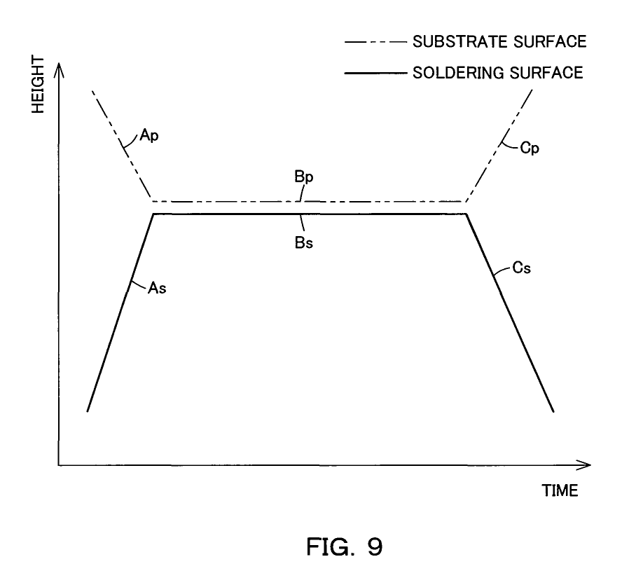

Thereby, as shown in FIG. 6, the molten solder is wetted up to the surface land 6 of the lead component mounting substrate 2 through the through-hole 4, and the solder fillet 8 of a suitable amount is formed between the lead 5 and the surface land 6.

In the secondary soldering step shown in FIG. 1 (b), the rear surface of the lead component mounting substrate 2 is relatively spaced from the soldering surface by controlling the power supply frequency of the electromagnetic induction pump 43 to lower the soldering surface of the molten solder Sb supplied to the upper end opening of the nozzle 52. In addition, only the lead 5 projected from the through-hole 4 of the lead component mounting substrate 2 is immersed in the molten solder Sb of the nozzle 52 for more than a certain period of time. This lead immersion state is maintained for several seconds.

Thereby, as shown in FIG. 6, the solder fillet 7 of a suitable solder amount is formed between the rear surface land 3 of the lead component mounting substrate 2 and the lead 5.

In the lead separating step shown in FIG. 1 (c), while the lead component mounting substrate 2 is tilted by rotating the feed screw 32 in a reverse direction with respect to the case of FIG. 1 (a) using the motor unit 31 to elevate the locking board 34, the lead component mounting substrate 2 is elevated in a tilting state by rotating the feed screw 19 in a reverse direction with respect to the case of FIG. 1 (a) using the motor unit 17 to elevate the elevating/lowering frame 22. Thereby, the lead 5 is separated from the soldering surface of the molten solder Sb of the nozzle 52 while the lead component mounting substrate 2 is tilted with the solder wave height of the molten solder Sb of the nozzle 52 maintained.

Next, the effect of the embodiment shown in FIG. 1 will be described.

In the primary soldering step shown in FIG. 1 (a), the molten solder is precipitatively wetted up to the surface side of the substrate on the lead 5 by applying an internal pressure into the through-hole 4 of the lead component mounting substrate 2 using the supply pressure of the molten solder Sa from the nozzle 52. Thereby, the solder fillet 8 of the surface side of the substrate can be reliably formed.

In the secondary soldering step shown in FIG. 1 (b), in a state where the rear surface of the lead component mounting substrate 2 is relatively spaced from the soldering surface of the molten solder Sb of the nozzle 52, only the lead 5 of the lead component mounting substrate 2 is immersed in the molten solder Sb of the nozzle 52 for more than a certain period of time to return the excessive solder amount adhered to the rear surface of the lead component mounting substrate 2 to the soldering surface of the molten solder Sb. The solder fillet 7 of the rear surface side of the substrate can be formed in a suitable molten solder amount. Thereby, the soldering defects such as a solder bridge between the plurality of leads 5 and a swelling solder fillet 7a (FIG. 8) of the rear surface side of the substrate can be suppressed.

Since the lead 5 is relatively separated from the soldering surface of the nozzle 52 while the lead 5 is tilted in the lead separating step shown in FIG. 1 (c), the tip face of the lead can be smoothly separated from the soldering surface, and the soldering defects such as a solder bridge between the leads, a swelling solder fillet 7a and an icicle of the lead tip can be suppressed.

Thus, if the solder fillet 8 of the surface side of the substrate is formed by applying an internal pressure into the through-hole 4 of the lead component mounting substrate 2 in the primary soldering step, high solder waves bring about defects at the time of forming the solder fillet 7 of the rear surface side of the substrate. Thereby, the demerits of the primary soldering step can be improved by providing the secondary soldering step due to low solder waves, and a normal solder fillet 7 can be formed at the rear surface side of the substrate.

In particular, when the lead component mounting substrate 2 is separated from the molten soldering surface in a state where the lead component mounting substrate 2 is tilted in order to realize a smooth lead separating operation, where slow separating speed is set, a time lag of the separating start of the lead existing at a high position and separating end of the lead existing at a low position is enlarged. Therefore, in the lead of the low position in which the solder immersion time until the separating end is long, the soldering defect such as the swelling solder fillet 7a (FIG. 8) is easily generated by the excessive rise of the solder. However, the excessive rise of the solder is prevented by providing the secondary soldering step due to the low solder waves, and the soldering defect can be suppressed.

Similarly, even when the tilting angle of the lead component mounting substrate 2 is small and the lead pitch is narrow, a solder bridge can be remarkably reduced, and a normal solder fillet 7 can be formed.

Next, FIG. 3 represents another embodiment of the local soldering method using a graph showing a change with the passage of time of the height positions of the substrate surface and nozzle soldering surface. Since the process until the primary soldering step a is the same as the primary soldering step shown in FIG. 1 (a), the description thereof is omitted.

The secondary soldering step b shown in FIG. 3 includes a fillet forming step b1 for relatively and gradually spacing the rear surface of the lead component mounting substrate 2 from the soldering surface of the molten solder Sb of the nozzle 52 to form the solder fillet 7 between the rear surface of the lead component mounting substrate 2 and the lead 5, and a finishing step b2 for fixing a spacing position of the soldering surface of the molten solder Sb of the nozzle 52 and rear surface of the lead component mounting substrate 2 to immerse only the lead 5 in the molten solder Sb.

In the lead separating step c, the lead 5 is separated from the molten soldering surface in the nozzle 52 by lowering the molten soldering surface in the nozzle 52 simultaneously with elevating the lead component mounting substrate 2.

FIG. 4 is a flow chart showing the local soldering method shown in FIG. 3. Circled numbers in this flowchart show step numbers.

(Step 1)

The molten soldering surface in the nozzle 52 is elevated by the frequency control of the electromagnetic induction pump 43 simultaneously with horizontally lowering the lead component mounting substrate 2 using the substrate elevating/lowering mechanism 13.

(Step 2)

The rear surface of the lead component mounting substrate 2 is put close to or brought into close contact with the upper end opening edge of the nozzle 52. The molten solder Sa ejected from the nozzle 52 is brought into contact with the rear surface of the lead component mounting substrate 2, and the soldering is started. In this soldering, the supply pressure of the molten solder Sa pressurized and supplied from the nozzle 52 is applied into the lead insertion through-hole 4 by elevating the soldering surface of the molten solder Sa. The solder is wetted up to the surface side of the substrate on the lead 5 in the through-hole 4, thereby reliably forming the surface solder fillet 8.

(Step 3)

The solder fillet 7 of the rear surface is reliably formed by gradually lowering the molten soldering surface ejected from the nozzle 52 by the frequency control of the electromagnetic induction pump 43 to separate the soldering surface of the molten solder Sb from the rear surface of the lead component mounting substrate 2 slowly.

(Step 4)

The power supply frequency of the electromagnetic induction pump 43 is maintained constant, and the soldering surface of the molten solder Sb is fixed apart by several millimeters from the rear surface of the lead component mounting substrate 2. A state where only the tip part of the lead 5 is brought into contact with the molten solder Sb is maintained for several seconds.

(Step 5)

The power supply frequency of the electromagnetic induction pump 43 is lowered to 0 Hz simultaneously with elevating the lead component mounting substrate 2 while the lead component mounting substrate 2 is tilted by the substrate elevating/lowering mechanism 13. The molten soldering surface in the nozzle 52 is lowered to the soldering surface level in the solder tank. During this operation, the lead 5 is separated from the molten soldering surface in the nozzle 52.

According to the embodiment shown in FIGS. 3 and 4, in addition to the effect of the embodiment shown in FIG. 1, in the fillet forming step b1 in the secondary soldering step b, the solder fillet 7 having a suitable shape can be formed by relatively and gradually spacing the rear surface of the lead component mounting substrate 2 from the soldering surface of the molten solder Sb of the nozzle 52. In the finishing step b2, the molten solder of a proper amount is permeated to only the lead 5 by fixing the spacing position of the soldering surface of the molten solder Sb of the nozzle 52 and rear surface of the lead component mounting substrate 2, and the soldering defect such as an icicle in which the solder hangs down from the lead tip can be effectively suppressed.

Next, still another embodiment of the local soldering method will be described based on FIG. 5.

At first, the local soldering method shown in FIG. 5 sets the plurality of electromagnetic induction pumps 43 collectively, and carries out a jog operation which is a pump operation of a waiting state. The local soldering method pressurizes and supplies the molten solder to the extent that the molten solder is not ejected from the nozzle 52, and maintains the temperature of the nozzle 52 and/or molten solder.

When starting the soldering, the height of the molten solder ejected from the upper end opening of the nozzle 52 is controlled so as to be maximum by collectively controlling the plurality of electromagnetic induction pumps 43. An operation of an overflow step for overflow-jetting the molten solder from the upper end opening of the nozzle 52, that is, an overflow operation is carried out. This overflow operation is a jet flow operation for removing the oxides in the nozzle 52.

The operation of the primary soldering step of applying the supply pressure of the molten solder supplied from the nozzle 52 into the through-hole 4 from the rear surface side of the lead component mounting substrate 2, that is, the primary soldering operation is carried out after this overflow operation. In fact, this primary soldering operation is a pumping operation for obtaining a high primary soldering surface for applying an internal pressure into the through-hole 4 of the lead component mounting substrate 2, and the plurality of electromagnetic induction pumps 43 are individually set with respect to each nozzle 52.

After this primary soldering operation, the operation of the secondary soldering step of relatively spacing the rear surface of the lead component mounting substrate 2 from the secondary soldering surface lower than the primary soldering surface by lowering the soldering surface of the molten solder ejected from the nozzle 52, and immersing only the lead 5 projected from the through-hole 4 of the lead component mounting substrate 2 in the secondary soldering surface in the nozzle 52 for more than a certain period of time, that is, the secondary soldering operation is carried out. In fact, this secondary soldering operation is a pumping operation capable of obtaining the secondary soldering surface lower than the primary soldering surface at the time of the solder separation, and controls the plurality of electromagnetic induction pumps 43 collectively.

After continuing this secondary soldering operation for a certain period of time, the method shifts to the lead separating step of relatively separating the lead 5 of the lead component mounting substrate 2 from the secondary soldering surface of the nozzle 52. The solder wave height is lowered by controlling the power supply frequency of the electromagnetic induction pump 43. Finally, the pump operation of the electromagnetic induction pump 43 is stopped by controlling the power supply frequency to 0 Hz, and the molten soldering surface in the nozzle is lowered to the soldering surface level in the solder tank body 41, completing the jet flow cycle.

Thus, there is provided the overflow step of making the molten solder overflow from the nozzle 52 immediately before the primary soldering step, and the primary soldering step is carried out after removing the molten solder flown out from the nozzle 52 and the oxides from the soldering surface of the nozzle 52 by the overflow step, thereby suppressing the soldering defect due to the oxides.

When the case where the secondary soldering operation is adopted is compared with the case where the secondary soldering operation is not adopted, an actual performance value is obtained, in which a bridge defective fraction when not adopting the secondary soldering operation is 10% to 20%, and a bridge defective fraction when adopting the secondary soldering operation is reduced to 0.5 to 0.7%.

Although the lead component mounting substrate 2 is elevated/lowered in the shown embodiment, the solder tank 14 or the nozzle 52 may be driven and elevated/lowered while the lead component mounting substrate 2 is maintained at a constant level.

In fact, as long as only the lead 5 can be immersed in the soldering surface in the nozzle 52 for more than a certain period of time in the secondary soldering step b, the height of the soldering surface or substrate surface may be changed in the finishing step b2 or in the secondary soldering operation.

Furthermore, although the present invention is effectively used for local soldering, the present invention is not limited to the local soldering, and can also be applied to usual jet flow type soldering.

1: A soldering method comprising:
the steps of applying supply pressure of molten solder supplied from a nozzle into a lead-insertion through-hole from a rear surface side of a lead component mounting substrate having a surface on which a lead component is mounted;
relatively spacing the rear surface of the lead component mounting substrate from a soldering surface of the nozzle and
immersing only a lead projected from the through-hole of the lead component mounting substrate in the soldering surface of the nozzle for more than a certain period of time; and
relatively separating the lead of the lead component mounting substrate from the soldering surface of the nozzle.

2: The soldering method according to claim 1,
further comprising the steps of:
relatively and gradually spacing the rear surface of the lead component mounting substrate from the soldering surface of the nozzle to form a solder fillet between the rear surface of the lead component mounting substrate and the lead; and
fixing a spacing position of the soldering surface of the nozzle and rear surface of the lead component mounting substrate to immerse only the lead in the molten solder.

3: The soldering method according to claim 1, wherein the relatively separating step separates the lead relatively from the soldering surface of the nozzle while tilting the lead of the lead component mounting substrate.

4: The soldering method according to claim 1, further comprising a step of overflowing the molten solder from the nozzle immediately before the applying step.
